(19) United States
(12) Patent Application Publication
(10) Pub. No.: US 2009/0066125 A1
(43) Pub. Date: Mar. 12, 2009

(54) Energy absorption device

(75) Inventors: Reiner Nett, Aschaffenburg (DE); Volker Porrmann, Aschaffenburg (DE); Rudiger Boll, Keilberg-Bessenbach (DE)

Correspondence Address: FOLEY AND LARDNER LLP;SUITE 500, 3000 K STREET NW, WASHINGTON, DC, 20007, US

(73) Assignee: TAKATA-PETRI AG

(21) Appl. No.: 12/230,544

(22) Filed: Aug. 29, 2008

Related U.S. Application Data
(63) Continuation of application No. PCT/EP2007/055929, filed on Jun. 14, 2007.

(30) Foreign Application Priority Data
Jul. 10, 2006 (DE) 20 2006 010 876.9

(51) Int. Cl. B60N 2/42

(52) U.S. Cl. 297/216.11; 297/216.1; 297/216.13

(57) ABSTRACT

An energy absorption device including an elastic core. The elastic core includes an elastic material, a covering enclosing the elastic core, and at least one flow device. Air contained in the elastic core may escape through the flow device into the space outside the covering when the elastic core is compressed. Additionally, air flows through the flow device into the space enclosed by the covering when the elastic core expands. The covering is constructed of a flexible, expansion-resistant material. The flow device is designed in the form of at least one connecting point between the covering elements of the covering such that air can escape from the elastic core or can flow into the elastic core through the connecting point.

### CROSS-REFERENCE TO RELATED PATENT APPLICATIONS

This application is a Continuation of International Patent Application No. PCT/EP2007/055929, filed Jun. 14, 2007, which was published in German as WO 2008/006664. The foregoing application is incorporated by reference herein in its entirety.

### SUMMARY

The present disclosure relates to an energy absorption device in the general field of seats, for example, for motor vehicles.

One disclosed embodiment relates to an energy absorption device for a vehicle seat including an elastic core. The elastic core includes an elastic material, a covering enclosing the elastic core, and at least one flow device. Air contained in the elastic core may escape through the flow device into the space outside the covering when the elastic core is compressed. Additionally, air may flow through the flow device and into the space enclosed by the covering when the elastic core expands. The covering is constructed of a flexible, expansion-resistant material. The flow device is designed in the form of at least one connecting point between the covering elements of the covering such that air can escape from the elastic core or can flow into the elastic core through the connecting point.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a cross sectional view of an energy absorption device according to an exemplary embodiment.

FIG. 2 is a child seat with an energy absorption device, according to an exemplary embodiment.

### DETAILED DESCRIPTION

According to an exemplary embodiment, an energy absorption device may be constructed as a cushion. The cushion may be constructed from a spring element that is supported under prestress on a covering as described in DE 43 33 499 A1, which is herein incorporated in its entirety. The covering may be composed of flexible material with a predetermined air passage. When the spring element is compressed, air that was previously contained in the spring element may escape out of the cushion through the covering.

The cushion is subjected to force over as extensive an area as possible in order to avoid an expansion of the compressed cushion material at cushion points that are not subjected to force. Therefore, similar cushions are not suitable for punctual or small-area energy absorption.

According to an exemplary embodiment, an energy absorption device may effectively absorb energy even if the energy that is to be absorbed acts on the device in a punctual manner or over a small area of the device. The energy absorption device may include an elastic core composed of an elastic material and a covering that encloses the elastic core. The covering may be composed of a flexible, expansion-resistant material. Additionally, the covering may include at least one flow device such that air contained in the elastic core escapes when the elastic core is compressed and flows into the elastic core when the elastic core expands.

In the context of the disclosure, expansion-resistant is understood as meaning a material that has very little elasticity in terms of expansion and preferably has a modulus of elasticity of at least 3 GPa.

To avoid a tearing of the material under high loads, the material of the covering includes a high tensile strength. The tensile strength is expressed, in particular, in a permissible tensile stress of the material of more than approximately 70 N/mm².

The expansion-resistant material of the covering restricts energy action in individual regions of the device from leading to an expansion of the elastic core at the other regions of the device where no energy to be absorbed acts. Therefore, the device may at least partially absorb energy that may be applied by a human body. Similar energy may result from, for example, an acceleration or braking energy acting on a vehicle occupant. Thus, the device may accordingly be configured such that the device may be suitable for installation in a motor vehicle.

The device may be dimensioned such that it can be integrated in a vehicle seat. The energy absorption device may replace or complement a conventional cushion in the region of a seat surface, a side rest and/or the backrest of a vehicle seat. Additionally, the energy absorption device may be provided with a further covering in addition to the covering enclosing the elastic core. The further covering may be, for example, a customary vehicle seat material.

According to an exemplary embodiment, the device is integrated in a child seat. In the region of the seat surface, the side rest and/or the backrest may replace or supplement the conventional cushions present in the child seat.

The covering material may be constructed of a flexible, expansion-resistant fabric that is composed of polyamide yarn. The fabric may be coated or uncoated with silicone or another suitable coating material. Polyester fabric and other expansion-resistant materials can also be used.

The covering may be of single or multi-part design. In a multi-part design, the individual covering parts or covering elements can be connected to one another by sewing, adhesive bonding and/or welding.

The covering enclosing the elastic core may be formed from one covering element and may be of multi-part design. In order to integrate a flow device in the covering without an additional working step, the flow device may be formed at one or more connecting points between the subregions of the covering. A similar connecting point may occur in either the single-part or multi-part design of the covering. In a multi-part design of the covering, a connecting point may be arranged between two covering halves. In a single-part design of the covering, a connecting point may be formed at the interconnected edges of the covering element. The connecting point may be a seam between the subregions of the covering.

According to an exemplary embodiment, the flow device may be formed by at least one cutout in the covering. The cutout may be a punched-out portion, an aperture or another opening in the covering material.

According to an exemplary embodiment, the flow device may be formed by the covering material. More particularly, the flow device may be formed by the air-permeable properties of the covering material. Thus, neither an air-permeable connecting point nor an air-permeable cutout has to be formed in the covering if the covering material itself has air-permeable properties. The covering material may be considered as having air-permeable properties if the covering has air-permeable pores.

Furthermore, one or more of the previously mentioned refinements and further possible refinements of a flow device may be combined.

The flow device may be configured such that the volume of air that passes through the flow device within a defined period of time can be controlled. The control can take place by valve that permits a defined throughput of air and may be placed onto a cutout in the covering.

Additionally, a motor vehicle seat may include an energy absorption device. The energy absorption device may be integrated in the motor vehicle seat as a cushion in the region of the seat surface, the side rest and/or the backrest.

According to an exemplary embodiment, the motor vehicle seat may be a child seat. In addition to the previously mentioned arrangements in the region of the seat surface, the side rest and/or the backrest, the energy absorption device may also be used as a side cushion of the child seat.

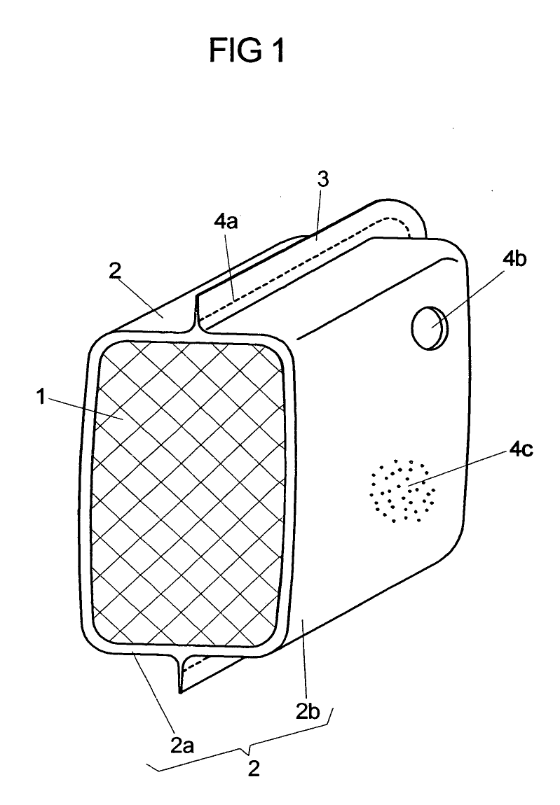

FIG. 1 shows a cross-sectional illustration of a cushion element as an energy absorption device with a foam core 1 as the elastic core and with a covering 2 that surrounds the foam core. The cushion element is part of a motor vehicle seat. The cushion element forms at least part of the backrest, the side rest and/or the seat surface of the motor vehicle seat. The cushion element may complement the single cushion of the motor vehicle seat or a conventional cushion in the backrest, the side rest and/or the seat surface of the motor vehicle seat.

The covering 2 includes a first planar subsegment 2a and a second planar subsegment 2b. Each subsegment 2a, 2b may constitute elements of the covering 2 that bear flat against one another in a connecting region 3. In the connecting region 3, the first subsegment 2a and the second subsegment 2b of the covering 2 may be connected to each other by a seam 4a, thereby forming a connecting point.

The subsegments 2a, 2b of the covering may be a silicone-coated technical fabric made of polyamide yarn (polyamide fabric) that may also be used as the airbag fabric. Thus, the covering material may be flexible with little elasticity in terms of expansion. The modulus of elasticity of the polyamide fabric lies at more than 3 GPa. Other materials with comparable properties may be suitable as the covering material. For example, an uncoated polyamide fabric or a polyester fabric may also be used. Furthermore, the material that is to be used may preferably have a high tensile strength.

In addition to the connecting function of the seam 4a, the seam 4a may also function as a flow connection between the interior of the covering 2 and the exterior of the covering 2. When the foam core 1 is compressed, air escaping from the foam core 1 can escape from the cushion element to the outside through the seam 4a.

Furthermore, FIG. 1 shows two additional possibilities for the configuration of a flow device. The covering 2 may include a circular opening 4b such that air can escape from the interior of the cushion element into the surroundings. In addition to the opening 4b, other openings may also be provided in the covering.

Additionally, the flow device may be configured using an air-permeable material as the material for the covering 2. The air-permeable material is indicated in FIG. 1 by the pores 4c that are illustrated.

According to an exemplary embodiment, an energy absorption device may include only one of the flow devices illustrated in FIG. 1. Furthermore, any combination of two different flow devices may be used.

According to an exemplary embodiment, an airtight seam may be formed between the two covering segments 2a and 2b. Furthermore, a different airtight connection of the two covering segments 2a and 2b may take place. The covering may also be designed as a single piece rather than including a plurality of covering segments 2a, 2b.

The comfort properties of the cushion element illustrated in FIG. 1 can easily be adjusted. For example, different foam materials can be used for the foam core 1.

The energy absorption capacity of the cushion material is dependant on air being discharged from the foam core 1. Therefore, in order to adjust the energy absorption capacity of the cushion material, the flow device can be designed in a variable manner and can be adapted to the cushion element properties desired in each case.

Furthermore, when the foam core 1 is compressed air may escape from the foam core 1 and from the cushion element through the seam 4a, the opening 4b, and/or the pores 4c in the covering material. A fully reversible, elastic resetting of the core material of the foam core 1 may be used to guide the escaped again back into the foam core 1. The escaped air may be guided back through the seam 4, the opening 4b and/or the pores 4c when the foam core 1 is relieved of load.

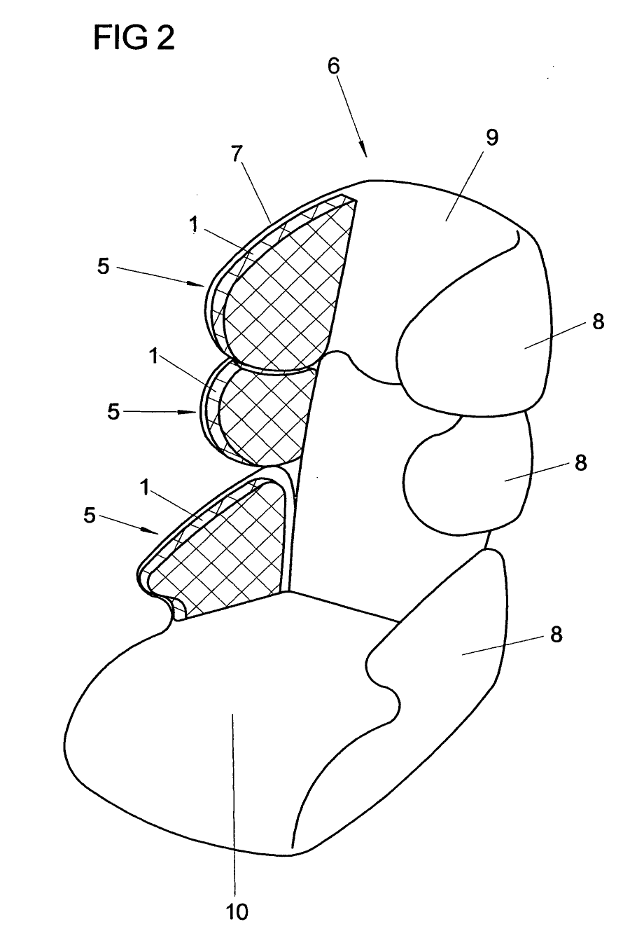

FIG. 2 shows an energy absorption device as a side cushion 5 of a child seat 6, according to an exemplary embodiment. FIG. 2 shows the foam core 1 of the energy absorption device while a covering 2 that surrounds the foam core 1 is not shown. The covering 2 may be used when the energy absorption device is used as a side cushion 5 or as a different cushion element. Use without a covering 2 is not provided.

Furthermore, in the illustration of FIG. 2, the child seat 6 only includes side cushions 5 on the inside of its right side rest 7, by way of example only. Therefore, an arrangement of an energy absorption device as side cushions on the inside of the left side rest 8 of the child seat 6 may also be included.

Furthermore, in addition to or in place of the side rests 7, 8 of the child seat 6, an energy absorption device may also arranged in the region of the back rest 9 and/or of the seat surface 10 of the child seat 6. Therefore, energy that acts on a child sitting in the child seat 6 may be absorbed at numerous points of the child seat 6. As a result, the comfort of the child seat 6 is increased with fewer cushions and/or with cushions that include unfavorable energy absorption properties.

Whether the side rests 7, 8, the backrest 9 and/or the seat surface 10 are of single or multi-part configuration is of secondary important to the effect of the energy absorption device. The configuration can be undertaken in accordance with ergonomic and/or aesthetic aspects.

The priority application, Germany Patent Application No. 20 2006 010 876.9, filed Jul. 10, 2006 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An energy absorption device, comprising:
an elastic core containing air, the elastic core including an elastic material and a covering enclosing the elastic material, the covering including at least one flow device through which air contained in the elastic material escapes into a space outside the covering when the elastic core is compressed and through which air flows into a space enclosed by the covering when the elastic core expands, wherein the covering comprises a flexible, expansion-resistant material, and
wherein the flow device includes at least one connecting point between elements of the covering such that air can escape from the elastic material or can flow into the elastic material through the at least one connecting point.

2. An energy absorption device, comprising:
an elastic core containing air and including an elastic material, and a covering enclosing the elastic material, the covering including at least one flow device through which air contained in the elastic material escapes into a space outside the covering when the elastic core is compressed and through which air flows into a space enclosed by the covering when the elastic core expands, wherein the covering comprises a flexible, expansion-resistant material, and
wherein the flow device is defined by air-permeable properties of the material of the covering such that air can escape from the elastic core or can flow into the elastic core through the material of the covering.

3. The energy absorption device as claimed in claim 1, wherein the material of the covering has a modulus of elasticity of 3 GPa or more.

4. The energy absorption device as claimed in claim 1, wherein the material of the covering has a permissible tensile stress of at least 70 N/mm².

5. The energy absorption device as claimed in claim 1, wherein the device is installed in a motor vehicle and at least partially absorbs energy that is applied by at least one vehicle occupant as a consequence of an acceleration acting on him/her.

6. The energy absorption device as claimed in claim 1, wherein the device is integrated in a vehicle seat.

7. The energy absorption device as claimed in claim 6, wherein the vehicle seat is a child seat.

8. The energy absorption device as claimed in claim 6, wherein the device is integrated in the vehicle seat in a region of a seat surface, a side rest, and/or a backrest.

9. The energy absorption device as claimed in claim 1, wherein the material of the covering is a polyamide fabric.

10. The energy absorption device as claimed in claim 1, wherein the covering comprises at least one covering element.

11. The energy absorption device as claimed in claim 1, wherein the at least one connecting point is a seam.

12. The energy absorption device as claimed in claim 1, wherein the flow device is formed by at least one opening in the covering through which air can escape from the elastic core or can flow into the elastic core.

13. The energy absorption device as claimed in claim 1, wherein the flow device is configured such that the volume of air that can pass through the flow device within a period of time can be controlled.

14. A motor vehicle seat comprising an energy absorption device, wherein the device comprises an elastic core containing air, the elastic core including an elastic material and a covering enclosing the elastic material, the covering including at least one flow device through which air contained in the elastic material escapes into a space outside the covering when the elastic core is compressed and through which air flows into a space enclosed by the covering when the elastic core expands, wherein the covering comprises a flexible, expansion-resistant material, and
wherein the flow device includes at least one connecting point between elements of the covering such that air can escape from the elastic material or can flow into the elastic material through the at least one connecting point.

15. The motor vehicle seat as claimed in claim 14, wherein the motor vehicle seat is configured especially for a child.
